(19) United States
(12) Patent Application Publication
(10) Pub. No.: US 2004/0236037 A1
(43) Pub. Date: Nov. 25, 2004

(54) Particulate coatings having improved chip resistance, UV durability, and color stability

(76) Inventors: Timothy S. December, Rochester Hills, MI (US); Lawrence Sacharski, Eastpointe, MI (US); Cynthia A. Stants, Pinckney, MI (US)

Correspondence Address: BASF CORPORATION, ANNE GERRY SABOURIN, 26701 TELEGRAPH ROAD, SOUTHFIELD, MI, 48034-2442, US

(21) Appl. No.: 10/440,974

(22) Filed: May 19, 2003

(51) Int. Cl. C08G 59/14

(52) U.S. Cl. 525/525

(57) ABSTRACT

The invention provides powder coatings having at least 25% by weight of an epoxy functional particulate component (a) having a T_{g} of at least 50° C. and of the structure:

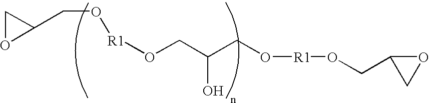

wherein n is a number from 0 to 15, and R₁ is selected from the group consisting of linear, branched or cycloaliphatic C₂-C₂₀ alkyl groups and mixtures thereof, based on the total weight of all epoxy functional particulate components in the powder coating composition. The powder-coating compositions of the invention are suitable for use as primers over electrocoat and under composite basecoat/clearcoat systems. Powder primers of the invention provide simultaneous improvements in yellowing, chip resistance, UV durability and color stability.

### FIELD OF THE INVENTION

The invention relates to powder coating compositions useful in automotive OEM applications, especially to chip resistant and colorfast powder primers for use over steel substrates.

### BACKGROUND OF THE INVENTION

Powder coating compositions, especially thermosetting powder coatings, have been used to provide a variety of advantages in the coating of articles. Applied as dry, finely divided particles, powder-coating compositions have several advantages as compared to conventional liquid solvent-based coatings.

Powder coating is a well-established process, basically comprising applying a powdered fusible material to a substrate, heating the powder in contact with the substrate to cause the powder to melt and reflow, and cooling the resultant melt to form a solid coating or film on the substrate. Powder coating compositions are intended to provide performance properties equivalent to those of traditional solvent based coating compositions without the complications of liquid organic solvents. In particular, the application and cure of powder coatings results in significantly reduced emissions of volatile organic compounds (VOC's). Powder coatings are also more amenable to recycling than traditional liquid coatings. As a result, powder-coating compositions have the potential to be environmentally and financially advantageous.

Powder coating compositions may be used as topcoats, basecoats, clearcoats, and/or primers. It is essential however, that the powder coating compositions provide the optimum balance of performance properties required by a particular application.

Powder primer coating compositions are generally required to provide good chip resistance, good flow and leveling, an excellent appearance and easy application properties.

Chip resistance may be generally defined as the ability of the primer to withstand the impact of a stone chip without loss of film integrity. Chip resistance is a particularly important performance property for automotive powder primers. Ideally, such compositions will consistently and uniformly provide a ‘barrier of last resort’ against the exposure of the underlying steel substrate to weathering elements comprising one or more factors such as light, heat, cold, water, salt, dirt and the like. It will be appreciated that it is desirable for primer compositions to provide such protection for as long as possible, regardless of the magnitude and extent of exposure to weathering elements. Thus, the most advantageous powder primer compositions will be those that substantially reduce or completely eliminate any exposure of the underlying steel substrate to weathering elements.

Prior art powder primer compositions, often based on polyurethane or aromatic epoxy/acid resin systems, have been used to provide chip resistance to electrocoated automotive steel substrates subsequently coated with composite basecoat/clearcoat systems. Unfortunately, however, such prior art powder primers have failed to provide all of the necessary performance benefits, especially with respect to chip resistance, UV durability, color stability and yellowing.

Many prior art powder primer compositions show an unacceptable number of chips as measured by standard gravelometer tests, i.e., ASTM SAE J400, and thus provide inadequate chip resistance.

Other prior art powder primers show a reduction in the number of chips in gravelometer tests but manifest a critical loss of adhesion between the powder primer and the underlying electrocoated steel substrate. That is, the resultant paint chips created and released by the impacting gravel are of all three paint films, i.e., primer, basecoat and clearcoat. While any loss of integrity in the composite coating is undesirable, it is the failure of the primer and the resultant exposure of the bare steel that results in relatively rapid damage. Thus, the advantages resulting from fewer gravelometer chips are outweighed by the relatively rapid damage resulting from the primer to steel failure mode.

Moreover, even when the adhesion of prior art powder primers to the electrocoated steel substrate is maintained, many exhibit another mode of undesirable gravelometer failure. In these cases, a critical loss of adhesion between the powder primer and the subsequently applied basecoat is observed. This failure mode results in the exposure of the powder primer surface to weathering elements rather than the electrocoated steel substrate. Unfortunately, powder primers of the prior art lack UV durability and color stability and are thus vulnerable to degradation and loss of film integrity upon exposure to sunlight. Although this degradation is less rapid than the damage caused by direct exposure of the steel substrate, these prior art powder primers fail to provide adequate levels of protection.

In addition, the performance and formulation requirements of prior art powder coatings have typically required a color and/or appearance that is very different from the subsequently applied colored basecoat. Not withstanding the fact that a chip showing a primer surface is better than a chip showing bare steel, automotive consumers disfavor the blatant appearance of primer colored chips against the composite basecoat/clearcoat film. Accordingly, it would be advantageous if powder primers could be colored to more closely approximate the appearance of the basecoat.

Finally, prior art powder coatings have generally not been colorfast or color stable. Indeed, powder primers based on aromatic epoxy/acid systems have often been vulnerable to yellowing. This lack of colorfastness contributes to the overall degradation of the exposed primer film and may result in more rapid exposure of the underlying steel substrate.

Thus, prior art powder coatings have failed to achieve the desired balance of properties, particularly with respect to both singular and simultaneous improvements in chip resistance, yellowing, color stability and/or UV durability.

It would therefore be desirable to provide powder coating compositions that provide improved automotive chip resistance.

In particular, it would be advantageous to provide powder coating compositions which exhibit a reduction in the total number of gravelometer chips as well as those gravelometer chips which illustrate a primer to steel substrate failure mode.

More particularly, it would advantageous to provide colored or tinted powder coatings having an appearance that is closer to that of subsequently applied basecoats but which simultaneously exhibit improvements in color stability, yellowing, UV durability and chip resistance.

### SUMMARY OF THE INVENTION

The invention provides advantages over the prior art with UV durable and color stable powder coating compositions that comprise at least 25% by weight of a particular epoxy functional particulate component (a), based on the total weight of all epoxy functional particulate components that are film-forming. Epoxy functional particulate component (a) must have a T_{g} of at least 50° C. and be of the formula:

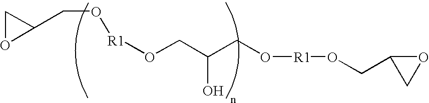

wherein n is a number from 0 to 15, R¹ is selected from the group consisting of linear, branched or cycloaliphatic alkyl C₂-C₂₀ groups and mixtures thereof.

More preferably, the powder coating compositions of the invention will comprise at least 25% by weight of the particularly required epoxy functional particulate component (a) and at least 25% by weight of an epoxy functional particulate component (b) having (i) a T_{g} of at least 50° C. and (ii) a backbone comprising one or more aromatic structures, wherein all %'s by weight are based on the total weight of epoxy functional particulate film-forming components (a) and (b).

In a most preferred embodiment, the powder coating compositions of the invention will further comprise at least one acid functional resin that functions as a crosslinking agent for epoxy functional particulate components (a) and (b). Preferred acid functional resins are acid functional acrylic resins, acid functional polyester resins, and mixtures thereof.

The powder coating compositions of the invention are especially suitable for use as primers over electrocoat and under composite basecoat clearcoat systems. Cured films made from the powder primers of the invention provide both singular and simultaneous improvements in yellowing, chip resistance, UV durability and color stability.

More particularly, cured multilayer films made with the powder coating compositions of the invention exhibit a reduction in the total number of gravelometer chips as well as those gravelometer chips which show a powder coating to steel substrate failure mode. As a result, cured multilayer films made with the powder coatings of the invention generally exhibit gravelometer chips having an exposed powder coating surface that continues to protect the underlying steel substrate due to the improved UV durability and color stability of the powder coatings of the invention.

### DETAILED DESCRIPTION OF THE BEST MODE

The powder coating composition requires the use of a particular epoxy functional particulate component (a). The term ‘particulate component’ as used herein refers to a material comprised of individual particles that are solid at room temperature. In a preferred embodiment, the particles will be nonagglomerating and fluid at room temperature.

Particulate component (a) must have a glass transition temperature (T_{g}) of at least 50° C., preferably from 60 to 110° C., more preferably greater than 70° C., and most preferably from 85 to 110° C. T_{g} may be defined as the characteristic temperature at which glassy amorphous polymers become flexible or rubber like because of the onset of segmental motion.

It is an aspect of the invention that the epoxy functional particulate component (a) have the structure:

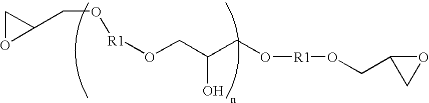

wherein n is a number from 0 to 15, and R¹ is selected from the group consisting of linear, branched and cycloaliphatic C₂-C₂₀ alkyl groups, and mixtures thereof.

While not wishing to be bound to a particular theory, it is believed that the improved performance properties of the claimed powder coatings are attributable to the unique structure of epoxy functional particulate component (a).

For example, the presence of the flexible polyether segments is believed to contribute to the improved chip resistance while the presence of the cycloaliphatic groups in the most preferred embodiment provides strength and improved UV durability. In addition, the presence of the polyether segments throughout the backbone and adjacent to the terminal epoxy groups results in increased reactivity of the epoxy groups. Thus, fewer epoxy groups are required, which is advantageous in terms of bake temperature requirements. Epoxy functional particulate components (a) suitable for use in the invention will generally have a number average molecular weight of from 1000 to 4000, more particularly from 1500 to 3000, and most preferably from 1600 to 2500 Daltons.

Put another way, n in the above formula will generally be a number of from 3 to 15. Most preferably, n will be a number of from 5 to 10, and most preferably will be a number of from 6 to 9.

Thus, in a most preferred embodiment, the epoxy functional particulate component (a) of the invention will be a number greater than 5. While not wishing to be bound to a particular theory, it is believed that the presence of the pendant hydroxy group(s) and/or polyether segments provides improvements in intercoat adhesion.

R¹ may be selected from the group consisting of linear, branched and cycloaliphatic C₂-C₂₀ alkyl groups, and mixtures thereof. Illustrative examples of R¹ include linear alkyl groups such as methy, ethyl, propyl, etc and branched alkyl groups such as isopropyl and isobutyl. Suitable cycloaliphatic groups include those having four, five and six membered rings, with six membered rings being especially preferred. Mixtures of cycloaliphatic groups and linear and branched alkyl groups are especially preferred.

In a preferred embodiment, R¹ will be of the formula:

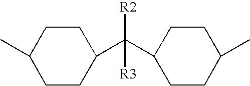

wherein R² and R³ may be the same or different and will generally be selected from the group consisting of hydrogen, linear and branched alkyl groups having from C₁ to C₂₀ carbons, and mixtures thereof.

Illustrative examples of suitable linear and branched alkyl groups for use as R² or R³ include methyl, ethyl, butyl and mixtures thereof. Preferred alkyl groups for use as R² or R³ are methyl, ethyl, and mixtures thereof, with methyl groups being most preferred substituent groups R₁ and R₂. In a preferred embodiment, R₁ and R₂ will be the same.

In a particularly preferred embodiment, epoxy functional particulate component (a) will be of the formula:

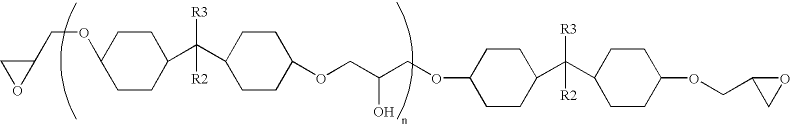

wherein n and R² and R³ are as defined above. In a most preferred embodiment, n will be a number from 5 to 10 and R² and R³ will be methyl.

Epoxy functional particulate component (a) will generally have more than 1.5 epoxy groups per molecule, preferably from 1.6 to 3.0 epoxy groups per molecule and most preferably from 2.1 to 2.8.

Suitable epoxy functional particulate components (a) will generally have an epoxy equivalent weight of from 600 to 1200 grams/eq epoxy, more preferably from 700 to 1100 grams/eq epoxy, and most preferably from 750 to 1050 grams/eq epoxy.

Suitable epoxy functional particulate components (a) may be obtained by the reaction of epichlorohydrin and a suitable polyol in the presence of a Lewis acid such as boron trifluoride to produce chlorohyrdrins followed by dehydrochlorination with a suitable base in a water immiscible base. Polyglycidyl ether is extracted as it forms. Illustrative polyols include butanediol, ethylene glycol, glycerin, hydrogenated bisphenol A, hydrogenated bisphenol F and the like. Hydrogenated bisphenols such as A and F are especially preferred, with hydrogenated bisphenol A being most preferred.

Alternatively, epoxy functional particulate components (a) useful in the instant invention may be obtained by the reaction of bisphenols such as bis A, F and the like and ephichlorhydrin followed by hydrogenation. Hydrogenation may be done via the use of hydrogen and platinum catalysts.

A commercially available example of a suitable epoxy functional particulate component (a) is ST-4100D from KUK DO Chemical Industry Co., LTD., of Korea.

In general, epoxy functional particulate component (a) will initially have an average particle size of from 0.1 to 100 microns but may be up to 2 to 3 centimeters in length. A preferred average particle size range for component (a) is from 3 to 60 microns. A 20 to 30 micron average particle size is most preferred. Traditional extrusion and grinding processes may be used to obtain solid epoxy functional particulate component (a) within these ranges. It will be appreciated that after admixing with the other components of the powder coating composition of the invention, the epoxy functional particular component (a) may undergo (additional) extrusion so as to have a final average particle size of from 10 to 40 as discussed below.

The powder coating compositions of the invention will have at least 25% by weight of epoxy functional particulate component (a), based on the total amount of epoxy functional particulate film-forming components present in the powder coating composition. In a preferred embodiment, the powder coating compositions of the invention will have from 25 to 100% by weight of epoxy functional particulate component (a), more preferably from 25 to 75% by weight, and most preferably from 45 to 65% by weight of epoxy functional particulate component (a), all based on the total weight of epoxy functional particulate film-forming components present in the powder coating composition.

It is another aspect of the invention that the powder coating compositions of the invention may further comprise from 0 to 75% by weight of an epoxy functional particulate component (b), based on the weight of all epoxy functional particulate components. Epoxy functional particulate component (b) will have a Tg of at least 50° C. and a backbone comprising one or more aromatic structures.

In general, epoxy functional particulate component (b) will generally be used in an amount of more than 0% by weight. In a preferred embodiment, the powder coating compositions of the invention will preferably contain at least 5% by weight of epoxy functional particulate component (b), preferably from 10 to 60% by weight, more preferably from 15 to 40% by weight, and most preferably from 20 to 30% by weight of epoxy functional particulate component (b), based on the weight of all epoxy functional particulate components that enter into the film-forming reaction.

As with epoxy functional particulate component (a), epoxy functional particulate component (b) must be a material comprised of individual particles that are solid at room temperature and most preferably, non-agglomerating at room temperature.

Particulate component (b) must have a glass transition temperature (T_{g}) of at least 50° C., preferably from 60 to 110° C., more preferably greater than 70° C., and most preferably from 85 to 110° C.

The term “one or more aromatic structures” may generally be defined as one or more repeating groups containing at least one six membered ring having three carbon-carbon double bonds within the ring structure. Epoxy functional particulate component (b) must have at least one such aromatic structure that is not pendant and is an internal part of the ‘backbone’ of epoxy functional particulate component (b). Thus, component (b) must have at least one aromatic structure wherein at least two different carbons within the six membered ring are each attached to at least one atom that is not within the six membered ring and is other than hydrogen, i.e., carbon, oxygen, nitrogen, silicon, and the like, with carbon and oxygen being most preferred. For example, in a most preferred embodiment, the at least two different carbons within the six membered ring will each be attached to either a carbon atom or an oxygen atom. The internal aromatic structures may thus preferably be attached to two carbon atoms, two oxygen atoms or a mixture thereof.

In a preferred embodiment, epoxy functional particulate component (b) will have from 2 to 20 aromatic rings in the backbone per molecule, more preferably from 4 to 15, and most preferably from 8 to 12 aromatic rings in the backbone per molecule.

Illustrative epoxy functional particulate components (b) will generally have a number average molecular weight of from 500 to 5000 Daltons, preferably from 800 to 4000, more preferably from 1000 to 3000, and most preferably from 1200 to 2000 Daltons.

Suitable epoxy functional particulate components (b) will generally have at least 2 epoxy groups per molecule, preferably from 2 to 3 epoxy groups per molecule and most preferably from 2.0 to 2.8.

Examples of suitable epoxy functional particulate components (b) include those materials containing epoxy ether groups, epoxy ester groups, and mixtures thereof. Suitable epoxy functional particulate components may be obtained from aromatic, aliphatic, and heterocyclic-aromatic dicarboxylic acids.

Typical examples of suitable dicarboxylic acids are phthalic acid, isophthalic acid, terephthalic acid, 2,5-dimethylphthalic acid, naphthalene-2,6-dicarboxylic acid, naphthalene-1,8-dicarboxylic acid, naphthalene-2,3-dicarboxylic acid, diphenyl ether 4,4′-dicarboxylic acid, diphenyl-2,2′-dicarboxylic acid, tetrachlorophthalic acid, 2,5-dichlorophthalic acid, o-, m- or p-phenylenediacetic acid, and the dicarboxylic acids obtainable by addition of acrylonitrile or acrylate to compounds having activatable hydrogen atoms, typically ketones, nitrogen compounds, diols or dithiols and the like, so long as said compounds having activatable hydrogen atoms contain at least one aromatic structure in the backbone, preferably at least two aromatic structures.

Other examples of suitable epoxy functional particulate components (b) include diglycidyl esters such as diglycidyl terephthalate or diglycidyl isophthalate and compounds having glycidylised aromatic hydroxyl groups, such as the diglycidyl ethers derived from

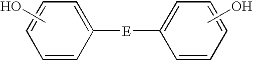

wherein E is —CH₂—, —C(CH₃)₂—, —O—, —S—, —SO—, or —SO₂—.

Other suitable epoxy functional particulate compounds (b) include diglycidyl ethers of formula (I):

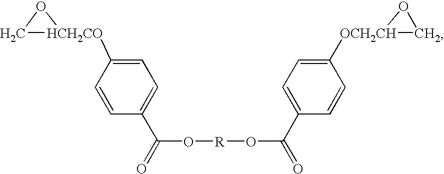

wherein R is an organic divalent radical of 2 to 15 carbon atoms. The divalent radicals R are preferably those derived from diols R(OH)₂ which are also customarily used as starting materials for polyesters, such as 1,2-ethanediyl, 1,2-propanediyl, 1,3-butanediyl, 1,4-butanediyl, 2,2-dimethyl-1,3-propanediyl, 1,6-hexanediyl, 2-ethyl-1,3-hexanediyl or groups of either of the following formula:

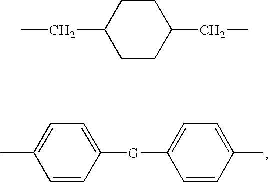

wherein G is —CH₂—, —C(CH₃)₂—, —O—, —S—, —SO— or —SO₂—.

Such suitable epoxy functional particulate compounds (b) may be obtained by conventional methods, typically by transesterifying methyl 4-hydroxybenzoate with the appropriate diol R(OH)₂ and then glycidylising with epichlorohydrin. Another similar process is described by H. KAKIUCHI and S. TAKEI in “New Epoxy Resins from Alkylene-bis-(p-hydroxy benzoate)”, Org. Coat. Plast. Chem. 1979, 40, 899-902.

Preferred for use as epoxy functional particulate component (b) are diglycidyl esters, diglycidyl ether, and mixtures thereof. Diglycidyl ethers are especially preferred for use as component (b) with diglycidyl ether of bisphenol A being most preferred.

It will be appreciated that the powder coating compositions of the invention may also comprise other epoxy functional particulate components that enter into the film-forming reaction in addition to epoxy functional particulate components (a) and (b). In one preferred embodiment, however, the powder coating of the invention will contain no epoxy functional particulate components other than epoxy functional particulate components (a) and (b).

Examples of epoxy functional particulate components (b′) different from epoxy functional particulate components (a) and (b) include acrylic resins containing glycidyl methacrylate. Epoxy functional particulate component (b′) will preferably have at least two epoxy groups per molecule, including saturated or unsaturated, aliphatic, cycloaliphatic or heterocyclic compounds and may be substituted with substituents such as halogen atoms, alkyl groups, ether groups and the like. Suitable polyepoxy resins include glycidyl ethers of aliphatic polyols, cycloaliphatic polyepoxides, epoxy-functional acrylic resins, heterocyclic polyepoxides, glycidyl esters of aliphatic polycarboxylic acids, glycidyl polyamines and ether amines, and mixtures thereof.

Epoxy functional particulate components (b′) other than epoxy functional particulate components (a) and (b) may also be used in amounts of from 0 to 20% by weight of all epoxy functional particulate components present in the powder coatings of the invention, more preferably from 2 to 10% by weight and most preferably from 3 to 8% by weight of all epoxy functional particulate components present.

The powder coating compositions of the invention may cure with self-crosslinking or via a reaction between the epoxy functional particulate component(s) (a), ((a) and (b)), or ((a), (b), and (b′)) with a crosslinking agent (c). Alternatively, a combination of a ring opening catalyst and a crosslinking reaction may be used to cure the powder coatings of the invention.

If the powder coating of the invention is self-crosslinking, it will comprise at least one ring opening catalyst to promote the generation of secondary hydroxyl groups. Examples of suitable ring opening catalysts include tertiary amines such as dimethylbenzyl amine and primary amines such as dimethylaminopropylamine. However, tertiary amines are more preferred than primary amines in as much as primary amines are believed to contribute to yellowing and/or decreased color stability.

Ring opening catalysts may generally be used in amounts of from 0 to 2 pphr, more preferably from 0 to 1, and most preferably from 0 to 0.5 pphr.

It is preferred that the powder coating compositions of the invention comprise a crosslinking agent (c).

Crosslinking agents (c) may generally be any compound, oligomer, or polymer having at least two functional groups reactive with the epoxy groups of epoxy functional particulate components (a) and (b).

Illustrative examples of suitable functional groups reactive with epoxy groups include carboxylic acid groups, amino groups such as tertiary amines and primary amines, hydroxyl groups, thiol, and amido. Reactive functional groups such as hydroxyl, amino, and carboxylic acid groups are preferred, with carboxylic acid groups being most preferred for use in crosslinking agent (c).

Crosslinking agents (c) will generally be solid at room temperature with a Tg approximately the same as that of epoxy functional particulate components (a) and (b).

Functional groups useful in the crosslinking reaction may be incorporated into a variety of compounds, oligomers, and polymers. In general, oligomers and polymers are preferred, with polymers being most preferred for use as crosslinking agent (c).

Illustrative crosslinking agents (c) include acid functional acrylic resins, acid functional polyesters, dimmer acids and mixtures thereof. Preferred crosslinking agents (c) are acid functional acrylics, acid functional polyesters, and mixtures thereof, with mixtures of acid functional acrylics and polyesters being most preferred.

Acid functional acrylic resins useful in the invention are formed from typical acrylic monomers known in the art. Illustrative examples include acrylic acid or methacrylic acid; acrylic acid derivatives such as methyl acrylate, ethyl acrylate, propyl acrylate, isopropyl acrylate, butyl acrylate, isobutyl acrylate, 2-ethylhexyl acrylate, isooctylacrylate, dodecyl acrylate, stearyl acrylate, cyclohexyl acrylate, benzyl acrylate, hydroxyethyl acrylate, hydroxypropyl acrylate, hydroxybutyl acrylate, 1,4-butanediol monoacrylate and dimethylaminoethyl acrylate; methacrylic acid derivatives such as methyl methacrylate, ethyl methacrylate, propyl methacrylate, isopropyl methacrylate, butyl methacrylate, isobutyl methacrylate, isooctylmethacrylate, 2-ethylhexyl methacrylate, dodecyl methacrylate, stearyl methacrylate, cyclohexyl methacrylate, benzyl methacrylate, phenyl methacrylate, hydroxyethyl methacrylate, hydroxylpropyl methacrylate, hydroxybutyl methacrylate, 1,4-butanediol monomethacrylate and dimethylaminoethyl methacrylate; and the like. Such monomers may be used separately or in mixtures thereof. Other monomers such as styrene, substituted styrene, vinyl toluene, and the like may also be used. Commercially available examples of the carboxylic acid functional acrylic resins include, e.g., those under the trademark designation SCX.TM. acrylic resins by S. C. Johnson.

Acid functional acrylics may generally have a number average molecular weight of from 500 to 10 000 Daltons, preferably from 1000 to 5000, and most preferably from 1500 to 3000.

Acrylic resins having acid numbers of from 10 to 100 are suitable, with acid numbers of from 15 to 60 being most preferred.

Acid functional acrylic resins may be generally be used in the powder coating compositions of the invention in amounts of from 10 to 60% by weight, preferably from 15 to 40% by weight, and most preferably from 20 to 30% by weight, based on the total weight of the powder coating composition. In general, the acid functional acrylics will generally be used in an amount such that the ratio of carboxyl groups to epoxy groups in the powder coating composition is from 0.5 to 2.0.

Illustrative polyesters useful as crosslinking agent (c) will generally have an acid number (mg KOH/g of polyester) of from 10 to 100, preferably from 10 to 80, and most preferably from 15 to 60, and a number average molecular weight of 500 to 10 000, preferably from 1000 to 5000, and most preferably from 1500 to 3000. The polyesters are preferably solid at room temperature and have a glass transition temperature of 35 to 120° C., preferably from 40 to 80° C.

Suitable polyesters will generally be the reaction products of polyols with dicarboxylic acids and, in some cases, polyfunctional carboxylic acids.

Representative examples of suitable polyols are ethylene glycol, propylene glycol, 1,3-butanediol, 1,4-butanediol, neopentanediol, isopentyl glycol, 1,6-hexanediol, glycerol, trimethylolethane, trimethylolpropane, erythritol, pentaerythritol or cyclohexanediol.

Typical examples of suitable dicarboxylic acids are isophthalic acid, terephthalic acid, phthalic acid, methylphthalic acids, tetrahydrophthalic acid, methyltetrahydrophthalic acid, cyclohexanedicarboxylic acid, succinic acid, glutaric acid, adipic acid, pimelic acid, suberic acid, azelaic acid, sebacic acid, fumaric acid, maleic acid, or 4,4′-diphenyldicarboxylic acid and the like. Suitable tricarboxylic anhydrides are the anhydrides of aliphatic tricarboxylic acid, such as 1,2,3-propanetricarboxylic acid, of aromatic tricarboxylic acid, such as trimellitic acid (benzene-1,2,4-tricarboxylic acid) and hemimellitic acid (benzene-1,2,3-tricarboxylic acid), or of cycloaliphatic tricarboxylic acid, such as 6-methylcyclohex-4-ene-1,2,3-tricarboxylic acid. Exemplary of suitable tetracarboxylic anhydrides are pyromellitic dianhydride or benzophenone-3,3′,4,4′-tetracarboxylic dianhydride.

Acid functional polyester resins may be generally be used in the powder coating compositions of the invention in amounts of from 10 to 60% by weight, preferably from 15 to 40% by weight, and most preferably from 20 to 30% by weight, based on the total weight of the powder coating composition. In general, the acid functional polyesters will generally be used in an amount such that the ratio of carboxyl groups to epoxy groups in the powder coating composition is from 0.5 to 2.0.

Catalysts may be used in the powder coating composition of the invention in an amount sufficient to cure the composition at a temperature of about 150° C. or below for about 30 minutes or less. Preferably, the catalyst is in an amount of from about 0 to about 2 pphr (parts per hundred resin), more preferably, from about 0 to about 1 pphr, and most preferably, from about 0 to about 0.5 pphr.

Examples of useful catalysts include imidazoles, imidazole/epoxy adducts, tertiary amines, imidazolines, imidazoline salts of mono- or di-carboxylic acids, tetraalkylammonium salts, phosphonium salts, tin catalysts e.g., stannous octoate, and mixtures thereof. Examples of imidazoles may include substituted and unsubstituted imidazoles, such as imidazole, 2-methylimidazole, and 2-phenylimidazole. Examples of imidazole/epoxy adducts can be commercially available under the trade designation EPON P-101 from Shell Chemical and under the trade designation XU HT 261 from Ciba-Geigy Corporation. Examples of tetraalkylammonium salts may include tetramethylammonium bromides, tetramethylammonium iodides, tetramethylammonium chlorides, myrystyltrimethylammonium bromides, myrystyitrimethylammonium iodides, myrystyltrimethylammonium chlorides, and the like. Examples of phosphonium salts may include ethyltriphenylphosphonium bromides, ethyltriphenylphosphonium iodides and ethyltriphenylphosphonium chlorides, and the like. Examples of tertiary amines may include N,N-dimethylcyclohexylamine, N,N-dimethylaniline, N-methylmorpholine, N,N′-dimethylpiperazine, 2,2,6,6,-tetramethyl-4-dimethylaminopiperidine, N,N-dimethyloctadecylamine, N,N-dimethylhexadecylamine, 1,8-diazabicyclo[5.4.0]undec-7-ene, N,N,N′,N′-tetramethylhexamethylenediamine, N,N,N′,N′,N″-pentamethyldiethylenetriamine, triethylenediamine and benzyldimethylamine. Examples of imidazolines include substituted and unsubstituted imidazolines, such as 2-phenylimidazoline. Imidazoline salts of mono- or di-carboxylic acids are derived from imidazoline-based compound and mono- or di-carboxylic acids. Suitable monocarboxylic acids and dicarboxylic acids have one or two carboxylic acid groups (—COOH) per molecule respectively. They include aromatic and aliphatic (saturated and unsaturated) acids and combinations thereof (i.e., araliphatic). Typical monocarboxylic acids or dicarboxylic acids include, but are not limited to, terephthalic acid, isophthalic acid, phthalic acid, benzoic acid, azelaic acid, adipic acid, succinic acid, glutaric acid, pimelic acid, suberic acid, sebacic acid, decanedicarboxylic acid, dodecandicarboxylic acid, acetic acid, 2-ethylhexanoic acid and maleic acid. Preferred mono- and di-carboxylic acids are adipic acid, sebacic acid and dodecanedioic acid. In a most preferred embodiment, no catalysts will be employed.

The powder coating compositions of the invention may contain other additives that are common to powder coatings. These additives include, without limitation, fillers, slip additives, pigments, dyes, UV stabilizers, antioxidants, fluidizing agents, flow control agents, degassing agents, flexibilizing agents and texturing agents, etc.

For example, flow control agents such as an acrylic compound, e.g., Modaflow 2000 or Resiflow P-67, or a silicon compound are known in the coating or powder coating art and are generally incorporated into the powder coating compositions to improve the surface tension, thereby facilitating the flow of the polymers as they are melted to provide a smoother finish of the final solid coatings.

Flexibilizing agents such as solid plasticizers, rubber, hydroxyl or acid functional polyester, styrene maleic anhydride and polyanhydride resins are used to provide a finish with more flexibility.

Examples of useful plasticizers may include sucrose benzoate, pentaerythritol tetrabenzoate and cyclohexanedimethanol dibenzoate. Examples of useful rubber may include natural and most synthetic rubbers, such as styrene-butadiene and acrylonitrile-butadiene polymers. Examples of useful polyesters may include those formed by the condensation reaction of aliphatic polyols, including cycloaliphatic polyols, with aliphatic and/or aromatic polycarboxylic acids and anhydrides. Examples of suitable aliphatic polyols may include 1,2-ethanediol, 1,3-propanediol, 1,4-butanediol, 1,6-hexanediol, neopentyl glycol, cyclohexane dimethanol, trimethlyopropene, and the like. Examples of suitable polycarboxylic acids and anhydrides may include succinic acid, adipic acid, azelaic acid, sebacic acid, terephthalic acid, isophthalic acid, tetrahydrophthalic acid, hexahydrophthalic acid trimellitic acid, and anhydrides of such acids. The flexibilizer, if needed, may be present up to 50%, preferably, from about 5% to about 30% by weight in the composition.

Pigments and fillers may be added to give the powder coatings color to provide a desired color, performance and/or rheology. Examples of suitable pigments and fillers include, but are not limited to, titanium dioxide, carbon black, barium sulfate, and organic and inorganic pigments of any available color depending on the application. The amounts of these additional additives depend upon the particular properties desired in the final coating.

The powder coating compositions of the invention may be prepared by conventional techniques employed in the powder coating art. Typically, the components of the powder coating composition are combined and thoroughly blended together and then melt blended and extruded in a single screw or twin-screw extruder. The extrudate is immediately cooled and then is grounded in a mill, such as a Brinkman mill, a Bantam hammer mill, an Alpine Mill or an ACM Mill, and sieved to obtain a powder of appropriate particle size depending on the application.

Although a wide range of particle sizes may be useful in the powder coating compositions of the invention, typical average particle sizes are from about 5 to about 250 micron. Preferably, the average particle size of the powder coating composition of the invention is from about 10 microns to about 80 microns, and more preferably, from about 20 to 30 microns.

The powder coating compositions of the invention are applied onto at least one of the surfaces of a substrate using any conventional powder coating deposition technique, such as electrostatic spray, to obtain smooth and uniform coatings.

The powder coating compositions of the invention may be applied to various conventional substrates such as metals, e.g., steel, or aluminum; glass; ceramic; carbon-fiber; plastic or fiber-reinforced plastic substrates; wood substrates, electrocoated substrates, previously coated substrates, and mixtures thereof. Previously coated and/or electrocoated metal and plastic substrates are especially preferred. Automotive metal substrates that have been electrocoated are especially preferred.

Curing is achieved by heating the coated substrate at a temperature for a time sufficient to cure the composition. Cure temperatures of from 150 to 200° C. are suitable, with cure schedules of from 150 to 180° C. for 10 to 30 minutes being especially preferred. It will be appreciated that the cure time varies depending on the cure temperature, the nature and the thickness of the substrate. Preferably, the cure time may be shorter than 30 minutes; more preferably, the cure time may be less than 20 minutes.

The thickness of the cured coatings of the invention varies depending on the application and performance requirements, but will generally range from about 1.0 mil to about 8.0 mils, preferably from 1.0 to 4.0 mils, and most preferably from 1.5 to 2.5 mils cured coating.

The invention is further illustrated by the following non-limiting examples. Those of skill in the art will understand, however, that many variations and modifications may be made while remaining within the scope of the present invention. All components are measured as indicated. All percentages are by weight unless otherwise noted.

### EXAMPLE 1

A gray powder primer was made according to the invention with 100% of epoxy functional particulate component (a) and 0% epoxy functional particulate component (b). The materials set forth in Table 1 were added in order to a 12 liter stainless steel vessel.

TABLE 1
(100% (a))

| Raw Material | | lbs. |
|---|---|---|
| | acid functional polyester¹ | 27.86 |
| | epoxy functional component (a)² | 38.30 |
| | acid functional acrylic resin³ | 5.44 |
| | benzoin | 0.49 |
| | epoxy functional component (b) | 00.00 |
| | flow additive⁴ | 1.22 |
| | trimethylolpropane | 0.31 |
| | trimethylolpropane | 0.31 |
| | TiO₂ | 12.24 |
| | carbon black | 0.24 |
| | barium sulfate | 36.03 |
| | Total | 122.13 |

¹acid number = 34
²epoxy resin based on hydrogenated bisphenol A
³acid number = 75, MW = 15,000
⁴polyether resin

The resulting powder mixture was pre-mixed on a Mighty-Mixer (Harold Lutzman Associates) for 39 seconds at 600 rpm. The pre-mix was then extruded on a ZWM Twin Screw Extruder (Werner and Pfleiderer) at 105C and 250 rpm. After extrusion the extruded material was cooled on a chilled roller and collected as chips. The chips were ground on an Air Classifying Mill (ACM from Hosokawa MicroPul 2L) at 2000 rpm. The particle size of the powder was about 22 to 26 microns.

The powder was applied to a 4″×12″ phosphated steel panel (available from ACT in Hillsdale, Mich.) and baked for 20 minutes (metal temperature) at 320° F. The film build was 1.5 to 2.0 mils.

### COMPARATIVE EXAMPLE

A powder coating using 100% of epoxy functional particulate component (b) was prepared using the raw materials of Table 2, according to the method of Example 1.

TABLE 2
(100% (D))

| Raw Material | lbs. |
|---|---|
| acid functional polyester⁵ | 27.86 |
| epoxy functional component (a)⁶ | 00.00 |
| acid functionl acrylic resin⁷ | 5.44 |
| benzoin | 0.40 |
| epoxy functional component (b) | 25.33 |
| flow additive⁸ | 1.0 |
| trimethylolpropane | 0.25 |
| TiO₂ | 10.02 |
| carbon black | 0.20 |
| barium sulfate | 29.50 |
| Total | 100.00 |

⁵acid number = 34,
⁶epoxy resin based on hydrogenated bisphenol A
⁷acid number = 75, MW = 15,000
⁸polyether resin

### EXAMPLE 2

A powder coating using 100% of 50% of epoxy functional particulate component (a) and 50% of epoxy functional particulate component (b) was prepared using the raw materials of Table 3, according to the method of Example 1.

TABLE 3
(50% (a)/50% (b))

| | |
|---|---|
| Raw Material | lbs. |

| | |
|---|---|
| acid functional polyester⁹ | 27.86 |
| epoxy functional component | 15.30 |
| (a)¹⁰ | |
| acid functional acrylic resin¹¹ | 5.44 |
| benzoin | 0.43 |
| epoxy functional component (b) | 15.30 |
| flow additive¹² | 1.0 |
| trimethylolpropane | 0.28 |
| TiO₂ | 10.90 |
| carbon black | 0.22 |
| barium sulfate | 32.10 |
| Total | 108.83 |

⁹acid number = 34,
¹⁰epoxy resin based on hydrogenated bisphenol A
¹¹acid number = 75, MW = 15,000

### EXAMPLE 3

A powder coating using 100% of 50% of epoxy functional particulate component (a) and 50% of epoxy functional particulate component (b) was prepared using the raw materials of Table 4, according to the method of Example 1.

TABLE 4
(25% (a)/75% (b))

| Raw Material | lbs. |
|---|---|
| acid functional polyester¹³ | 27.86 |
| epoxy functional component | 22.95 |
| (a)¹⁴ | |
| acid functional acrylic resin¹⁵ | 5.44 |
| benzoin | 0.43 |
| epoxy functional component (b) | 7.65 |
| flow additive¹⁶ | 1.0 |
| trimethylolpropane | 0.28 |
| TiO₂ | 10.90 |
| carbon black | 0.22 |
| barium sulfate | 32.10 |
| Total | 108.83 |

¹³acid number = 34,
¹⁴epoxy resin based on hydrogenated bisphenol A
¹⁵acid number = 75, MW = 15,000
¹⁶polyether resin

### EXAMPLE 5

The compositions from Examples 1-3 and the Comparative Example were evaluated for chip resistance. Sample panels were prepared by applying the powder primer compositions from Examples 1-3, and the Comparative Example to steel panels. The powder primer coatings were then cured by baking at 30 minutes×170° C. to obtain cured film builds of from 1.5 to 2.5 mils dried film. The sample panels were then coated with a silver basecoat (R99AJ005 commercially available from BASF Corporation of Southfield, Mich.) and a 1 K carbamate/melamine clearcoat (R10CG0600 commercially available from BASF Corporation of Southfield, Mich.) followed by flashing for 10 minutes at 25° C. and baking for 24 minutes at 132° C.¹⁷ The basecoat was applied to obtain a dry film build of from 0.5 to 0.7 mils, while the clear coat was applied to obtain dry film builds of from 1.7 to 2.1 mils. ¹⁷ The silver basecoat was omitted for he

The sample panels were evaluated for cold chip resistance per ASTM SAEJ400. The panels were placed in a constant temperature freezer at (−25C) for a minimum of 4 hours. The stones for the gravel test were shot at the panel with an air pressure of 70 psi. A total of 3 pints of gravel stones were used. The amount of paint loss was measured using an image-analyzing instrument. (Atlas VIEEW Digital Image Analyzer from Atlas MTT GmbH, Germany)

Chip resistance after weathering was evaluated per SAEJ400 test method. The amount of paint loss was measured using an image-analyzing instrument. (Atlas VIEEW Digital Image Analyzer from Atlas MTT GmbH, Germany).

The results of the cold chip resistance and the chip resistance after weathering are set forth below in Table 5

TABLE 5

| | | % Paint | | % Paint |
|---|---|---|---|---|
| Exam- | | Loss in | Chip Failure | Loss/1000 hrs |
| ple # | Type | Cold Chip | Mode | QUV¹⁸ |
| Com- | 100% Epoxy | 2.1 | POOR/more | 40% |
| parative | Functional | | than 75%- | |
| Exam- | Particulate | | Fails at | |
| ple 1 | Component | | steel/primer | |
| | (b) | | interface/results | |
| | | | in exposure of | |
| | | | bare steel | |
| Exam- | 100% Epoxy | 4.3 | GOOD/Less | 15% |
| ple 1 | Functional | | than 10%- | |
| | Particulate | | Fails at | |
| | Component | | steel/primer | |
| | (a) | | interface/results | |
| | | | in exposure of | |
| | | | bare steel | |
| Exam- | 50% Epoxy | 1.6 | GOOD/less | 3% |
| ple 2 | Functional | | than 20%- | |
| | Particulate | | Fails at | |
| | Component | | steel/primer | |
| | (a) and 50% | | interface/results | |
| | Epoxy | | in exposure of | |
| | Functional | | bare steel | |
| | Particulate | | | |
| | Component | | | |
| | (b) | | | |

It can therefore be seen that the use of epoxy functional particulate component (a), either alone or in combination with an aromatic epoxy functional particulate component (b), provides improvements in both the amount of paint lost in chip resistance tests and in the type of failure mode.

1. A UV durable and color stable powder coating composition, comprising at least 25% by weight of an epoxy functional particulate component (a) having a T_{g} of at least 50° C. and of the formula: 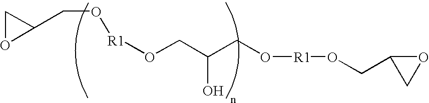
wherein n is a number from 0 to 15, R₁ is selected from the group consisting of linear, branched and cycloaliphatic C₂-C₂₀ alkyl groups and mixtures thereof, and the % by weight is based on the total weight of all epoxy functional particulate film-forming components.

2. The powder coating composition of claim 1 further comprising
at least 25% by weight of an epoxy functional particulate component (b) having a T_{g} of at least 50° C. and a backbone comprising one or more aromatic structures, wherein the % by weight is based on the total weight of epoxy functional particulate components (a) and (b).

3. The powder coating composition of claim 1 wherein n is an integer of from 5 to 15.

4. The powder coating composition of claim 3 wherein R¹ is of the formula wherein R² and R³ are selected from the group consisting of linear and branched C₁ to C₂₀ alkyl groups.

5. The powder coating composition of claim 1 wherein R₂ is H.

6. The powder coating composition of claim 1 wherein R₂ is a C₁ to C₂₀ alkyl group.

7. The powder coating composition of claim 6 wherein R₂ is a C₁ to C₆ alkyl group.

8. The powder coating composition of claim 5 wherein R₃ is H.

9. The powder coating composition of claim 5 wherein R₃ is a C₁ to C₂₀ alkyl group.

10. The powder coating composition of claim 5 wherein R₂ is a C₁ to C₂₀ alkyl group.

11. The powder coating composition of claim 1 having no more than 5% loss of adhesion on an ASTM SAE J400 gravelometer test.

12. The powder coating composition of claim 1 comprising from 25% to 75% by weight of epoxy functional particulate component (a).

13. The powder coating composition of claim 12 comprising from 45% to 65% by weight of epoxy functional particulate component (a).

14. The powder coating composition of claim 2 comprising from 0 to 75% by weight of epoxy functional particulate component (b).

15. The powder coating composition of claim 14 comprising from 10 to 60% by weight of epoxy functional particulate component (b).

16. The powder coating composition of claim 1 wherein the epoxy functional particulate film-forming component (a) has more than 1.5 epoxy groups per molecule.

17. The powder coating composition of claim 1 further comprising at least one acid functional component (c).

18. The powder coating composition of claim 17 wherein the at least one acid functional component (c) is selected from the group consisting of acid functional acrylic resins, acid functional polyester resins, and mixtures thereof.

19. The powder coating composition of claim 18 wherein the at least one acid functional component (c) is an acid functional acrylic resin.

20. The powder coating composition of claim 19 wherein the at least one acid functional component (c) is a acid functional polyester resin.

21. The powder coating composition of claim 1 further comprising one or more pigments selected from the group consisting of titanium dioxide, carbon black, and mixtures thereof.

22. A UV durable and color stable powder coating composition, comprising
at least 25% by weight of an epoxy functional particulate component (a) having (i) a T_{g} of at least 50° C., and of the formula 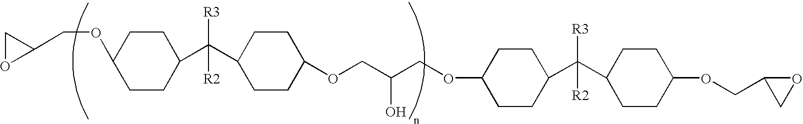
wherein n is a number from 0 to 15 and R² and R³ may be the same or different and are selected from the group consisting of linear and branched C₁ to C₂₀ alkyl groups and mixtures thereof, and
at least 25% by weight of an epoxy functional particulate component (b) having (i) a T_{g} of at least 50° C. and (ii) a backbone comprising one or more aromatic structures,
wherein all %'s by weight are based on the total weight of epoxy functional particulate film-forming components (a) and (b).

23. The powder coating composition of claim 22 wherein R₂ and R₃ are methyl groups and n is from 5 to 10.

24. A method of obtaining a cured composite coated substrate having improved chip resistance and UV durability, comprising
applying a powder coating to a substrate to provide a powder coated substrate,
applying a least one topcoat coating to the powder coated substrate to provide a composite coated substrate,
curing the at least one topcoat to provide a cured composite coated substrate, and
subjecting the cured composite coated substrate to SAE J400 gravelometer to obtain less than 10% of chips having a failure mode showing delamination between the at least the powder coating and the substrate, based on the total number of chips and as determined by image analysis,
wherein the powder coating comprises at least 25% by weight of an epoxy functional particulate component (a) having a T_{g} of at least 50° C. and of the formula: 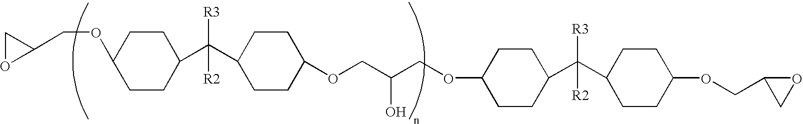
wherein n is a number from 0 to 15, R² and R³ may be the same or different and are selected from the group consisting of linear and branched C₁ to C₂₀ alkyl groups and mixtures thereof, and the % by weight is based on the total weight of all epoxy functional particulate film-forming components.

25. The method of claim 24 wherein the substrate is bare steel.

26. The method of claim 24 wherein the substrate is has been electrocoated.

27. The method of claim 24 wherein the powder coating is cured prior to application of the at least one topcoat.

28. The method of claim 24 wherein the topcoat comprises a multicoat coating system

29. The method of claim 28 wherein the multicoat coating system comprises a composite coating.

30. The method of claim 29 wherein the composite coating comprises a clearcoat and a basecoat.

31. The method of claim 30 wherein the clearcoat and basecoat are applied wet on wet.
